(19) United States
(12) Patent Application Publication
(10) Pub. No.: US 2005/0244984 A1
(43) Pub. Date: Nov. 3, 2005

(54) Methods and compositions for calibrating chemical array readers

(76) Inventor: Russell Alan Parker, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/834,423

(22) Filed: Apr. 28, 2004

(51) Int. Cl. G01N 1/00

(52) U.S. Cl. 436/172; 422/82.05; 422/61

(57) ABSTRACT

The invention provides compositions for calibrating a fluorescence reader. The subject compositions generally relate to a solid support coated in a fluorescent agent, where the solid support has minimal local and global nonuniformities of fluorescence. Also provided by the invention are methods of calibrating a scanner using the subject compositions, and kits and programming for performing the subject methods.

### BACKGROUND OF THE INVENTION

Arrays of biopolymeric binding agents have become an increasingly important tool in the biotechnology industry and related fields. These arrays, in which a plurality of biopolymeric binding agents are deposited onto a solid support surface in the form of an array or pattern, find use in a variety of applications, including gene expression analysis, drug screening, nucleic acid sequencing, mutation analysis, and the like.

In array-based assays in which an array of binding agents is employed, the array surface is typically contacted with one or more analytes, such as polynucleotide analytes, receptor proteins or antiligand molecules, under conditions that promote specific, high-affinity binding of the analyte molecules to one or more of the array members. Typically, the goal is to identify one or more position-addressable members of the library array which bind to the analyte, as a method of screening for array compounds which bind the analyte. Typically, the analytes are labeled with a detectable label such as a fluorescent agent, which indicates the regions in which analyte binding to the array has occurred.

Once the binding of the analyte to one or more array members has occurred, the arrays are read, usually by optical means, where a variety of optical scanning devices are available for reading such arrays (see for example U.S. Pat. Nos. 5,324,633 and 5,585,639, the disclosures of which are herein incorporated by reference). The optical means included in these array scanning devices typically includes a light source, e.g., a laser or the like, for transmitting light onto the array and a detector, e.g., a photomultiplier or the like, for detecting a parameter of the transmitted light, e.g., fluorescence, etc. Typically, data corresponding to the amount of light signal obtained for each pixel detected is produced by the scanner, and this data may be examined to evaluate the level of a particular analyte in a sample.

It is imperative that these scanners perform consistently. In other words, it is important that the light source and detector accurately and precisely detect the level of fluorescence across the entire surface of the array, and that such detection is consistent amongst scanners. Thus, it would be advantageous if biopolymeric array scanners could be periodically calibrated to achieve and maintain consistency, precision and accuracy, and to ensure that variations between optical scanners are minimized, i.e., each optical scanner produces substantially the same results as any other scanner. More precisely, it would be advantageous if the optical components of the scanner, e.g., the light source and/or light detector and certain other optical components of the system including the scanning lens(es), optical stage and the scanner mirror(s), were periodically checked and, if necessary, re-adjusted.

Typically, the optical means of a scanner are calibrated during manufacture. Methods and devices are known for calibrating light sources (see for example U.S. Pat. Nos. 5,464,960 and 5,772,656). However, few are known for calibrating optical components, such as an optical detector for example, after manufacture. Thus, optical detectors and various other optical components are usually not calibrated periodically, due to the lack of an easy, precise and inexpensive end-user calibration tool. However, one method that has been developed to calibrate optical detectors of scanners after manufacture uses a substrate having a pattern of reflective metal, typically chromium, thereon. The method relies solely on the reflection of light from the chromium pattern, where such reflective light measurements are used to calibrate the optical detector of the scanner. One disadvantage with this system is that although it is capable of calibrating the scanner's positioning mechanism with high precision, it lacks the capability to detect power changes in the laser or reduced responses in the detector. Another disadvantage associated with this method is that it is wavelength insensitive. In other words, using reflectance to calibrate the optical detector of an optical scanner that is intended to scan fluorescently labeled probes, does not evaluate the optical detector of the scanner in regards to the wavelength of light that will ultimately be emitted, e.g., fluorescence, when an actual array is scanned by the optical scanner. Another significant disadvantage is that the chromium tool does not include a means to subtract background signal from the reflectance data, aside from the dark current typical of all detectors, and thus the reflectance data may be over or under estimated which may then skew the calibration of the optics.

As such, there is a still a need for methods and compositions for calibrating scanners. This invention meets this need, and others.

Relevant Literature

U.S. patent documents of interest include U.S. Pat. Nos. 4,868,105; 5,124,246; 5,242,974; 5,384,261; 5,405,783; 5,412,087; 5,424,186; 5,429,807; 5,436,327; 5,445,934; 5,472,672; 5,527,681; 5,529,756; 5,545,531; 5,554,501; 5,556,752; 5,561,071; 5,563,034; 5,585,639; 5,599,695; 5,624,711; 5,631,734; 5,639,603; 5,658,734; 5,681,702; 5,922,612; 5,040,047 and 5,981,956. Other documents of interest include WO 93/17126; WO 95/11995; WO 95/35505; WO 97/14706 and WO 98/30575; WO 98/24933; EP 742287; EP 799897; WO 01/59503; Chen Y., et al., Journal of Biomedical Optics (1997) 2:364-374; and DeRisi J. L. et al. Science (1997) 278:680-686; and published U.S. Patent Applications 20030165871 and 20030105195.

### SUMMARY OF THE INVENTION

The invention provides compositions for calibrating a fluorescence reader. The subject compositions generally relate to a solid support coated in a fluorescent agent, where the solid support has minimal local and global nonuniformities of fluorescence and contains a plurality of photobleached regions. In many embodiments, the compositions are made by coating a solid support a fluorescent agent, and photobleaching regions of the coated solid support having levels of fluorescence above a pre-determined threshold level of fluorescence. Also provided by the invention are methods of calibrating an array reader using the subject compositions, and kits and programming for performing the subject methods. The subject invention finds use in a variety of fluorescence scanners, including biopolymeric array scanners.

### BRIEF DESCRIPTIONS OF THE DRAWINGS

FIG. 1 shows an exemplary embodiment of a biopolymeric array scanner for use in the subject methods.

FIG. 2 shows a graph of data obtained from photobleaching a non-uniformly fluorescent solid support.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

A “biopolymer” is a polymer of one or more types of repeating units. Biopolymers are typically found in biological systems and particularly include polysaccharides (such as carbohydrates), peptides (which term is used to include polypeptides and proteins) and polynucleotides as well as their analogs such as those compounds composed of or containing amino acid analogs or non-amino acid groups, or nucleotide analogs or non-nucleotide groups. Biopolymers include polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. Biopolymers include DNA (including cDNA), RNA, oligonucleotides, and PNA and other polynucleotides as described in U.S. Pat. No. 5,948,902 and references cited therein (all of which are also incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (e.g., a single amino acid or nucleotide with two linking groups one or both of which may have removable protecting groups).

An “array,” includes any two-dimensional or substantially two-dimensional (as well as a three-dimensional) arrangement of addressable regions bearing a particular chemical moiety or moieties (e.g., biopolymers such as polynucleotide or oligonucleotide sequences (nucleic acids), polypeptides (e.g., proteins), carbohydrates, lipids, etc.) associated with that region. In the broadest sense, the preferred arrays are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, photolithographic array fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse jets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used such as described in U.S. Pat. No. 5,599,695, U.S. Pat. No. 5,753,788, and U.S. Pat. No. 6,329,143. Interfeature areas need not be present particularly when the arrays are made by photolithographic methods as described in those patents.

An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probe” may be the one which is to be evaluated by the other (thus, either one could be an unknown mixture of polynucleotides to be evaluated by binding with the other). A “scan region” refers to a contiguous (preferably, rectangular) area in which the array spots or features of interest, as defined above, are found. The scan region is that portion of the total area illuminated from which the resulting fluorescence is detected and recorded. For the purposes of this invention, the scan region includes the entire area of the slide scanned in each pass of the lens, between the first feature of interest, and the last feature of interest, even if there exist intervening areas which lack features of interest. An “array layout” refers to one or more characteristics of the features, such as feature positioning on the substrate, one or more feature dimensions, and an indication of a moiety at a given location. “Hybridizing” and “binding”, with respect to polynucleotides, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination which will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

A “reader” refers to any device for evaluating arrays, including an array imager and an array scanner. An “array imager” captures a two-dimensional wide-field image of an array, e.g., an entire array or multi-pixel region thereof, and may employ a CCD or other detector. An “array scanner” moves a field of illumination across an array, typically in a line or series of lines, and reads light emitted from the array. In many scanners, an optical light source, particularly a laser light source, generates a collimated beam. The collimated beam is focused on the array and sequentially illuminates small surface regions of known location (i.e. a position) on an array substrate. The resulting signals from the surface regions are collected either confocally (employing the same lens used to focus the light onto the array) or off-axis (using a separate lens positioned to one side of the lens used to focus the onto the array). The collected signals are then transmitted through appropriate spectral filters, to an optical detector. A recording device, such as a computer memory, records the detected signals and builds up a raster scan file of intensities as a function of position, or time as it relates to the position. Such intensities, as a function of position, are typically referred to in the art as “pixels”. Biopolymer arrays are often scanned and/or scan results are often represented at 5 or 10 micron pixel resolution. To achieve the precision required for such activity, components such as the lasers must be set and maintained with particular alignment. Scanners may be bi-directional, or unidirectional, as is known in the art.

The scanner typically used for the evaluation of arrays includes a scanning fluorometer. A number of different types of such devices are commercially available from different sources, such as such as Perkin-Elmer, Agilent, or Axon Instruments, etc., and examples of typical scanners are described in U.S. Pat. Nos. 5,091,652; 5,760,951, 6,320,196 and 6,355,934.

The term “assessing” and “evaluating” are used interchangeably to refer to any form of measurement, and includes determining if an element is present or not. The terms “determining,” “measuring,” and “assessing,” and “assaying” are used interchangeably and include both quantitative and qualitative determinations. Assessing may be relative or absolute. “Assessing the presence of” includes determining the amount of something present, as well as determining whether it is present or absent.

The term “using” has its conventional meaning, and, as such, means employing, e.g. putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

### DETAILED DESCRIPTION OF THE INVENTION

The invention provides compositions for calibrating a fluorescence reader. The subject compositions generally relate to a solid support coated in a fluorescent agent, where the solid support has minimal local and global nonuniformities of fluorescence and contains a plurality of photobleached regions. In many embodiments, the compositions are made by coating a solid support a fluorescent agent, and photobleaching regions of the coated solid support having levels of fluorescence above a pre-determined threshold level of fluorescence. Also provided by the invention are methods of calibrating a scanner using the subject compositions, and kits and programming for performing the subject methods. The subject invention finds use in a variety of fluorescence readers, including biopolymeric array scanners.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a laser” includes a plurality of such lasers and reference to “the array” includes reference to one or more arrays and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As summarized above, the present invention provides methods and compositions for use in calibrating a scanner. In further describing the present invention, methods for producing the subject compositions will be described first, followed by a detailed description of the compositions themselves. After these descriptions, exemplary applications for the subject compositions will be reviewed. Finally, representative kits and computer programming for use in practicing the subject methods will be discussed.

Method of Making Composition for Calibrating a Biopolymeric Array Reader

As mentioned above, the invention provides a uniformly fluorescent solid support for use in calibrating a biopolymeric array reader. In general, the subject uniformly fluorescent solid supports are made by photobleaching regions of a non-uniformly fluorescent solid support that have a level of fluorescence above a pre-determined threshold level. Methods of making these compositions are set forth in detail below.

Non-Uniformly Fluorescent Solid Supports

As discussed above, uniformly fluorescent solid supports are typically made from non-uniformly fluorescent solid supports. The subject non-uniformly fluorescent solid supports are described below.

The non-uniformly fluorescent solid supports used in the subject methods are typically planar, may be constructed using any suitable material, and are typically dimensioned for insertion into a biopolymeric array scanner. Such solid supports are typically non-uniformly fluorescent and usually have greater than about 0.5% (e.g., greater than about 1%, greater than about 2%, greater than about 3% or greater than about 5%) local and global nonuniformity in fluorescence.

Typical non-uniformly fluorescent solid supports may be rigid (i.e., does not readily bend) or flexible (i.e., capable of being bent, folded or similarly manipulated without breakage). Rigid solid supports may be made from silicon, glass, rigid plastics, e.g. polytetrafluoroethylene, polypropylene, polystyrene, polycarbonate, etc., or metals, e.g. gold, platinum, etc. Flexible solid supports may be made from a variety of materials, such as, for example, nylon, nitrocellulose, polypropylene, polyester films, e.g., polyethylene terephthalate, polymethyl methacrylate or other acrylics, polyvinyl chloride or other vinyl resin. Various plasticizers and modifiers may be used with polymeric substrate materials to achieve selected flexibility characteristics.

Solid supports may exist in a variety of configurations ranging from simple to complex. The subject solid supports are typically of dimensions that can be inserted into and scanned using a typically biopolymeric array scanner. Thus, subject solid supports typically have overall rectangular, square or disc configuration. In many embodiments of the subject invention, the substrate will have a rectangular shape, having a length of from about 10 mm to 200 mm, usually from about 20 to 150 mm and more usually from about 30 to 100 mm and a width of from about 5 mm to 100 mm, usually from about 10 mm to 50 mm and more usually from about 15 mm to 40 mm, and a thickness of from about 0.01 mm to 5.0 mm, usually from about 0.1 mm to 2 mm and more usually from about 0.2 to 1 mm. In one embodiment, a solid support has dimensions similar to that of a typical microscope slide, e.g., about 25 mm by 75 mm. The above dimensions are, of course, exemplary only and may vary as required.

As mentioned above, non-uniformly fluorescent solid supports are typically fluorescent. Accordingly, the subject supports typically comprise at least one fluorescent agent that may be covalently or non-covalently bound by the support.

Fluorescent agents used in the subject methods are typically photobleachable fluorescent agents and detectable by typical biopolymeric array scanners. Such solid supports may contain more than one fluorescent agent, e.g., two or more detectably different fluorescent agents. Specific fluorescent agents of interest include at least one of, but are not limited to: xanthene dyes, e.g. fluorescein and rhodamine dyes, such as fluorescein isothiocyanate (FITC), 2-[ethylamino)-3-(ethylimino)-2-7-dimethyl-3H-xanthen-9-yl]benzoic acid ethyl ester monohydrochloride (R6G)(emits a response radiation in the wavelength that ranges from about 500 to 560 nm), 1,1,3,3,3′,3′-Hexamethylindodicarbocyanine iodide (HIDC) (emits a response radiation in the wavelength that ranged from about 600 to 660 nm), 6-carboxyfluorescein (commonly known by the abbreviations FAM and F), 6-carboxy-2-,-7,-4,-7-hexachlorofluorescein (HEX), 6-carboxy-4′,5′-dichloro-2′,7′-dimethoxyfluorescein (JOE or J), N,N,N′,N′-tetramethyl-6-carboxyrhodamine (TAMRA or T), 6-carboxy-X-rhodamine (ROX or R), 5-carboxyrhodamine-6G (R6G⁵ or G⁵), 6-carboxyrhodamine-6G (R6G⁶ or G⁶), and rhodamine 110; cyanine dyes, e.g. Cy3 (emits a response radiation in the wavelength that ranges from about 540 to 580 nm), Cy5 (emits a response radiation in the wavelength that ranges from about 640 to 680 nm) and Cy7 dyes; coumarins, e.g umbelliferone; benzimide dyes, e.g. Hoechst 33258; phenanthridine dyes, e.g. Texas Red; ethidium dyes; acridine dyes; carbazole dyes; phenoxazine dyes; porphyrin dyes; polymethine dyes; BODIPY dyes and quinoline dyes. Specific fluorophores of interest include: Pyrene, Coumarin, Diethylaminocoumarin, FAM, Fluorescein Chlorotriazinyl, Fluorescein, R110, Eosin, JOE, R6G, HIDC, Tetramethylrhodamine, TAMRA, Lissamine, ROX, Napthofluorescein, Texas Red, Napthofluorescein, Cy3, and Cy5, etc.

Where at least two or more are agents are used, any combination of suitable agents may be used, where particular combinations of interest include R6G, i.e., 2-[ethylamino)-3-(ethylimino)-2-7-dimethyl-3H-xanthen-9-yl]benzoic acid ethyl ester monohydrochloride and HIDC, i.e., 1,1,3,3,3′,3′-Hexamethylindodicarbocyanine iodide; Cy3 (Indocarbocyanine) and Cy5 (Indodicarbocyanine); and other suitable combinations, where combinations of green and red dyes are of particular interest.

Non-uniform fluorescent solid supports may be made using any method available. In typical embodiments, a solid support is coated in a fluorescent agent. For example, a fluorescent agent may be conjugated, directly or indirectly, to the surface of an activated or derivatized solid support, which methods are well known in the art. In certain embodiments, the fluorescent agent is present in a layer, particularly a polymer layer that coats a solid support. The coating may be formed by any convenient method, including, but not limited to, draw coating, roller coating, electrocoating, dip coating, spin coating, spray coating, or any other suitable coating technique wherein a solution or suspension is deposited onto the support surface. Oftentimes, deposition of the polymer layer will be followed by drying via vacuum, forced air oven, convection oven, or other drying technique.

In certain embodiments, at least one polymeric layer, usually a single polymeric layer such as a thin monolayer (or a plurality thereof) having a fluorescent agent is coated on a surface of the substrate, is deposited over substantially an entire surface of the solid support. A variety of polymers may be used, where such a polymer will typically be rigid, thermally stable, photo non-reactive, non-fluorescent, chemically resistant and substantially transparent across the wavelength region of interest. Representative materials suitable for use include, but are not limited to, acrylates such as polyacrylates, polymethyl-methacrylate, polyacrylamide, polyacrylic acid, epoxides such as polyglycidoxyether polyethylene oxide, polyprolyleneoxide, urethanes such as various polyurethanes, and may also include polycarbonates, polyolefins, polyetherketones, polyesters, polystyrenes, polyethylstyrene, polysiloxanes, and the like, and copolymers thereof. In certain embodiments, the support may also have a fluorescent coating of RNA, DNA, or other organic species that contains a bleachable dye and an organic or inorganic backbone.

Any coating may have a substantially uniform thickness, i.e., the thickness of the polymer layer does not vary significantly across its area, but rather is substantially constant. By significantly is meant that the deviation in the thickness across the area of the polymer layer is usually less than about 0.05% to about 20% and more usually less than about 0.1% to about 10%. More particularly, the thickness of the polymer layer usually ranges from about 0.25 microns to about 10 microns, usually from about 0.40 microns to about 7 microns and more usually from about 0.40 microns to about 1 micron with a deviation of less than about 0.05% to about 20% and more usually with a deviation of less than about 0.1% to about 10%.

Accordingly, using the methods and compositions set forth above, a non-uniformly fluorescent solid support may be produced. A subject non-uniformly fluorescent solid support is typically converted into a uniformly fluorescent solid support using photobleaching methods. These methods are described in greater detail below.

Photobleaching Methods

In general, a non-uniformly fluorescent solid support is used to make a uniformly fluorescent solid support by photobleaching areas of the non-uniformly fluorescent solid support that have a level of fluorescence above a “threshold level of fluorescence”, where a threshold level of fluorescence is a pre-determined level of fluorescence that is detectable by a typical biopolymeric array scanner. In other words, any areas of a non-uniformly fluorescent solid support that fluoresce at an intensity above a pre-determined threshold intensity are photobleached until they fluoresce at the threshold intensity.

Typically, a threshold level of fluorescence lies between the maximal level detectable by a biopolymeric array reader (i.e., the level at which fluorescence signals become saturated) and the minimal level detectable by a scanner (i.e., that level at which fluorescence signals are discernable from “background” signals, e.g., signals representing non-fluorescent areas). A threshold level of fluorescence is also typically below or equal to that of the area of lowest fluorescence of a non-uniformly fluorescent solid support. Accordingly, while a very wide range of threshold levels may be chosen for the subject methods, a suitable threshold level may be determined experimentally by scanning a non-uniformly fluorescent solid support using a fluorescence scanner: a suitable threshold level is above background and below the lowest level of fluorescence of the support. A threshold level is usually within the dynamic range of a reader's detection system, usually in the middle of the dynamic range.

Readers that are commonly used for scanning biopolymeric arrays typically have a 16-bit output, meaning that the fluorescence intensity of each pixel in a scan is quantified using number equal to or below 65,536 (i.e., 2¹⁶). Accordingly, in many cases, suitable thresholds for use in the subject methods include intensities of 1-10,000, 10,001-20,000, 20,001-30,000, 30,001-40,000, 40,001-50,000, 50,001-60,000 or 60,001-65,635. Typically, a suitable threshold is an intensity of fluorescence is represented by a range of numbers, e.g., a number plus or minus a percentage (for example, 1%, 3%, 5%, 10%, 15% or 20%) of that number. Of course, these numbers may be adjusted according to the number of bits used for scanning.

Several types of light may be used for photobleaching in the subject methods. In many embodiments, visible light of a wavelength of about 400 nm to about 720 nm may be used, e.g., 500 nm to 640 nm or 550 nm to 590 nm. In particular embodiments 480-500, 520-540, 580-600, 630-640 may be used. In general and depending on which type of light is used for photobleaching, the photobleaching light may have an intensity of 0.1-0.5 W/cm², 0.5-1 W/cm², 1-5 W/cm², 5-10 W/cm², 10-50 W/cm², 50-100 W/cm², 100-500 W/cm², or greater than 500 W/cm².

In general, a molecule of fluorescent agent is inactivated by photobleaching to produce a chemically modified, inactive, version of the fluorescent agent. The subject photobleaching methods may be performed using a variety of different photobleaching methods. Solely to illustrate these methods and without any intention to limit the invention to any embodiments actually described, two exemplary photobleaching methods that may be employed to make a uniformly fluorescent solid support from a non-uniformly fluorescent solid are described in detail below.

Methods Employing Light Masks

In certain illustrative embodiments of the invention, the subject photobleaching methods may be performed using a light mask. In these embodiments, a non-uniformly fluorescent solid support is typically scanned using a fluorescence reader, e.g., a scanner, to produce an image, the image is used to make a light mask, and the light mask is employed during photobleaching of the non-uniformly fluorescent solid support. In most embodiments, the most fluorescent areas and the least fluorescent areas of the solid support correspond to the most and least transparent areas of the mask, respectively. Any non-transparent areas (i.e., opaque areas) of a subject mask may correspond to regions of a non-uniformly fluorescent solid support that have a level of fluorescence that is at a desired threshold level of fluorescence. By applying a photobleaching light to the non-uniformly fluorescent solid support through the mask, regions of the solid support that have higher levels of fluorescence are photobleached at a faster rate than regions having lower levels of fluorescence, and, after a period of time, a uniformly fluorescent solid support is produced.

In these methods, a non-uniformly fluorescent solid support may be read using a fluorescence reader, e.g., a biopolymeric array reader, to provide a data file for the solid support. The data file is typically a text file containing a numerical assessment of the brightness each pixel of a scan, however, any file format, including a graphical file format, may be used instead. In general terms, the light mask is designed using this file. Specifically, the data file may be used to create an image of the scanned non-uniformly fluorescent solid support, and this image, after any necessary adjustments thereto, is reproduced on a light transparent media, e.g., a transparent sheet of plastic such as Mylar, acrylates, polycarbonates, styrene, any type of media used to create transparencies for projection, or a sheet of glass and the like. In most embodiments, the subject mask, once produced, is the same size as and may be placed (directly or indirectly) on top of a non-uniformly fluorescent solid support, and registered so that the bleaching mask and substrate are optimally aligned.

In particular embodiments, the image is reproduced by a printing the image onto a transparent media, where “printing” includes any contact or non-contact printing methods known in the art. As is well known in the art, such methods may transfer a liquid, e.g. a dye, ink or any opaque reactive chemical onto a medium, or, in other embodiments, may transfer energy, heat or light, to an energy sensitive substrate. In other embodiments, a mask may be printed by photographic means, e.g., by exposing a light-sensitive medium to an image of the non-uniformly fluorescent solid support using photographic means, e.g., a lens system. Accordingly, the word “printing” is intended to broadly encompass any method of transferring an image onto a receptive medium. In typical embodiments, the system used will accommodate printing at a suitable resolution. Accordingly, suitable printing systems include those having a continuous or near continuous resolution, e.g., photographic systems having an emulsion of light sensitive material, or a resolution, measured in spot size, of at least about 1 μm, at least about 5 μm, at least about 10 μm, at least about 15 μm, at least about 20 μm, at least about 25 μm, at least about 30 μm, at least about 35 μm, at least about 40 μm, usually up to about 50 μm or 100 μm. In certain embodiments, the printing system has a resolution that is equal to that of the system scanning used to scan the non-uniformly fluorescent solid support.

As mentioned above, in certain embodiments, the image of the non-uniformly fluorescent solid support may be adjusted, i.e., altered, prior to its employment in making a mask. In particular, the brightness and/or contrast of the image may be adjusted to make the brightest areas of the scan correspond to the most transparent regions of the mask, and, in certain embodiments, the least bright areas of the scan correspond to the least transparent regions (e.g., functionally opaque regions) of a mask. In certain embodiments, the brightest areas of the image are adjusted to be as bright as possible, whereas the least bright areas of an image are adjusted to be as dark as possible (to produce opaque regions of a mask).

Once made, a subject mask is usually placed over the non-uniformly fluorescent solid support for which the mask was designed, and the solid support illuminated, through the mask, by a photobleaching light. In typical embodiments, the photobleaching light is usually a light produced by a laser. The light may be a beam of light which may be as broad or narrow in dimensions as required, or scattered light. If laser light is used, the light may be non-collimated, e.g., non-parallel or unfocussed. This may be achieved using a defocusing screen, which screens are well known in the art. The time for which a non-uniformly fluorescent solid support may be subjected to photobleaching light may vary, and may be easily be determined. In certain embodiments, a subject solid support is exposed to a photobleaching light for a period of time, and the photobleached solid support is re-scanned to determine if it should re-exposed to photobleaching light. Accordingly, by undergoing repeated cycles of photobleaching and scanning, a desired uniformly fluorescent solid support may be produced. In other embodiments, the “photobleaching coefficient” of a fluorescent agent may be known (i.e., the rate of its decrease in fluorescence in a particular light), and, accordingly, the solid support may be exposed to an amount of light that may be calculated using the photobleaching coefficient of the fluorescent agent. In other words, a suitable time that a non-uniformly fluorescent solid support should be exposed to a particular light in order to make a uniformly fluorescent solid support may be estimated using a known rate of photobleaching of the fluorescent agent used, in that light.

Accordingly, in certain illustrative embodiments, a non-uniformly fluorescent solid support may be scanned, typically using a fluorescence scanner, e.g., a biopolymeric array scanner, to provide a data file, and the data file is used to generate a pixilated image, usually a grey-scale image, of the solid support. The image, or the data file used to generate the image, is assessed to identify the most and least bright areas of the image. These areas may correspond to a single pixel, or a group of contiguous pixels of the image. In these embodiments, the image may be scaled such that the brightest area of the image has maximal possible brightness, and the least bright area of the image has minimal possible brightness. Such methods may be performed using the “autoscale” feature of many graphics programs (e.g., the PHOTOSHOP™ program of Adobe Inc., San Jose, Calif.). The subject images may be scaled linearly or non-linearly, as desired. In certain embodiments, the image may also be altered to provide for correct mask/solid support positioning. Accordingly, the perimeter of the solid support, or any other indicators, e.g., scribe marks, may be drawn onto the image or the image may be placed into a pre-drawn template. The scaled image, including any alterations that provide correct positioning, is then printed onto transparent film to produce a mask. The mask is then placed on top of the solid support, usually using marks on the mask that provide for correct positioning, and the solid support is exposed to photobleaching light, e.g., a non-collimated laser light, through the mask for a suitable period of time, usually 1 min to 24 hr, 5 min to 8 hr, 10 min to 4 hr or 30 min to 2 hr.

In certain embodiments, the subject methods may be performed using a mask produced by a liquid crystal display (LCD).

Accordingly, using the above-described mask-based photobleaching methods, a uniformly fluorescent solid support may be made from a non-uniformly fluorescent solid support.

Methods Employing Fluorescence Readers

In other illustrative embodiments of the invention, the subject photobleaching methods may be performed using a fluorescence reader, e.g., a biopolymeric array scanner, that may be programmed to photobleach areas of the non-uniformly fluorescent solid support that are above a threshold level of fluorescence, and thereby produce a uniformly fluorescent solid support. One feature of these embodiments is that an area having a level of fluorescence above a threshold level of fluorescence may be identified by scanning the area to provide a numerical assessment of the area, and comparing that assessment to a pre-determined threshold for the area. That area, if it has a level of fluorescence above the selected threshold, may then be photobleached, typically using the same laser as used for its assessment.

Accordingly, in these embodiments, a non-uniformly fluorescent solid support is typically placed in a scanner, and regions of the solid support that have a levels of fluorescence above a pre-determined threshold level are photobleached by assessing their fluorescence; and photobleaching any region having a level of fluorescence above a threshold level, until they have a desirable level of fluorescence. Typically, these methods involve: a) placing a non-uniformly fluorescent solid support in a scanner; b) assessing fluorescence of a first region of the solid support using the scanner; c) photobleaching the first region of the solid support using a laser of the scanner until the region has a pre-determined level of fluorescence; d) assessing fluorescence of a second region of the solid support using the scanner and, e) photobleaching the second region using the same laser until the second region also has the pre-determined level of fluorescence. In general, these assessing and photobleaching steps are repeated until every area of the solid support has a similar level of fluorescence, i.e., the solid support has uniform fluorescence. While not necessary for performing these methods, the intensity of a scanner laser may be adjusted so that the laser light is at a higher intensity during photobleaching, and at a lower intensity during scanning. Such adjustments may be done using methods well known in the art, and typically involve altering the input voltage of a laser or any attenuator thereof, usually using a electro-optical modulator (EOM).

In these methods, a region of any size may be first scanned and then photobleached prior to scanning and photobleaching of a second region.

In particular embodiments, a photobleached region corresponds to the smallest area of a solid support from which a numerical assessment of fluorescence is obtained. In other words, the region of a solid support that is photobleached typically corresponds to a pixel in a scan of the array. Such a region is referred to herein as a “pixel”. Pixel dimensions typically correspond to the resolution of the scanner used. For example, such regions are typically 1-5 μm in size, about 5 μm in size, about 10 μm in size, or greater, usually up to about 20 μm, 50 μm or 100 μm in size, where these number generally refer to the resolution of the scanner.

Accordingly, the subject methods may involve assessing the level of fluorescence of a first pixel, and, if the level is over a chosen threshold level, photobleaching the pixel until a threshold level of fluorescence is reached. In certain embodiments, the pixel may be photobleached by exposing the pixel to light for a fixed period of time, e.g., 1 μs, 2 μs, about 5 μs, about 10 μs, about 20 μs, about 50 μs, about 100 μs, about 500 μs, or about 1 ms, for example, and then reassessed by the scanner to determine if the pixel has been photobleached to the desired level. If the pixel has a level of fluorescence above the desired level, the pixel may be repeatedly photobleached and assessed until the threshold level is reached. In other embodiments, the time needed to reduce fluorescence of a pixel to a threshold level may be calculated after the pixel has been assessed and before it is photobleached using methods described above, i.e., by estimating the time using a known rate of photobleaching of the fluorescent agent used. Once a threshold level is reached for a first pixel, second, third, and other pixels on the solid support may be assessing and photobleached using the same methods. By employing this method for every pixel of a solid support, a uniformly fluorescent solid support may be produced from a non-uniformly fluorescent solid support.

In other embodiments, a photobleached region corresponds to an area containing a plurality of pixels, e.g., a line of pixels, an entire readable region of a substrate or any sub-region thereof. In these embodiments, an area of pixels is read to provide an assessment of the brightness of each pixel in the area, and pixels of the area are later photobleached according to their brightness. In general, the laser intensity is increased as it passes over brighter pixels, and decreased as it passes over weaker pixels, and, for pixels that are already deemed to be at the threshold level of fluorescence, the laser may be off. As discussed briefly above, laser intensity may be modulated using methods well known in the art that typically involve altering the input voltage of a laser or any attenuator thereof, usually using a electro-optical modulator (EOM). Array scanners having a variable laser attenuators, such as the scanners described in U.S. Pat. No. 6,406,849, find particular use in these methods.

Accordingly, by assessing an area of pixels, and then photobleaching any pixels of that area that are above a pre-determined threshold level of fluorescence, an area of pixels having a uniform level of fluorescence may be obtained. If the first area photobleached is not the entire region to be photobleached, these methods may be repeated for other areas of pixels and a solid substrate having a uniform level of fluorescence may be produced. For example, an area of a substrate may be read using a reader to provide a data file that is stored in memory, and the data file used to coordinate changes in laser power/voltage, according to the methods described above, as the area is being scanned by the photobleaching laser.

Computer-Related Embodiments

The invention also provides a variety of computer-related embodiments. Specifically, the methods described above may be in the form of programming, and the programming may be read by a computer processor and executed by various components of an array reader system, particularly an EOM and servo motor components. Accordingly, the invention provides programming for assessing the intensity of a first region of a solid support, determining if the region has above a desired level of fluorescence, and photobleaching the region according to the methods described above. In one exemplary embodiment, a pixel is assessed to provide a numerical assessment of the brightness pixel, and, using the subject programming, the numerical assessment is compared to a number representing the chosen threshold level of fluorescence. If the numerical assessment is above the threshold level, then the software instructs a laser, via an EOM, to fire at the pixel. Once the laser has fired, the pixel may be reassessed, and, if the pixel is not yet at a desired level of fluorescence, the assessing/photobleaching cycle may be repeated until the pixel is at a desired level of fluorescence. In other embodiments, particularly those in which a line of pixels is assessed prior to photobleaching, a memory may be used to store instructions prior to their execution.

Accordingly, automated methods for photobleaching a non-uniformly fluorescent solid support to provide a uniformly fluorescent solid support are also provided by the subject invention.

In most embodiments, the above methods are coded onto a computer-readable medium in the form of “programming”, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. The subject programming may be present in a computer system.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

Compositions for Calibrating a Biopolymeric Array Reader

A uniformly fluorescent solid support for calibrating an optical reader, e.g., a biopolymeric array scanner, is provided herein. In general, a subject uniformly fluorescent solid support typically contains a field of uniform fluorescence. Typically, this field corresponds to the readabe region (the area that that may be read, e.g., scanned) of a solid support, and typically encompasses at least about 50%, at least about 60%, at least about 70%, at least 80% or at least 90% of the solid support. For example, for rectangular solid supports that are planar (such as those shaped like a microscope slide), such a field may be rectangular or square and approximately 20-24 mm×70-75 mm, 20-24 mm×45-50 mm, or 20-24 mm-20-24 mm in size. In general, the subject compositions are dimensioned so that they may be placed in an optical scanner for calibration of that scanner. In other words, subject compositions are typically dimensioned for placement in an optical scanner.

In general, the subject uniformly fluorescent solid support is a solid support coated in a fluorescent agent, wherein the solid support has minimal local and global nonuniformities of fluorescence and contains a plurality of photobleached regions. In general and in the absence of any further physical modifications to the subject solid support (e.g., modifying the shape of the solid support by, for example, cutting the solid support into pieces), the subject uniformly fluorescent solid support is typically physically identical to the non-uniformly fluorescent solid support from which it was made, except that it contains photobleached regions and has uniform fluorescence. In certain embodiments, the solid support comprises a polymer layer containing the fluorescent agent, and the fluorescent agent is distributed uniformly throughout the polymer.

A subject uniformly fluorescent solid support has minimal local and global variations in fluorescence, i.e., the local and global variations in fluorescence are minimal. The exact local and global fluorescence variation may vary depending on a variety of factors such as the specific device to be calibrated, and the variation desired. In general, local and global variation is minimized to a degree sufficient to enable calibration, as described below, of the particular optical scanner employing the subject device.

By local variation is meant that the light emitted from each pixel in a certain area is substantially the same or constant. With regard to local nonuniformities of fluorescence of a subject calibration device, in certain embodiments, the difference between the fluorescence detected from each pixel in an area of the subject device is typically less than about 3%, usually less than about 2% and more usually less than about 1%, 0.7%, 0.5%, 0.2% or 0.1%. Local nonuniformity is usually based upon a local area having about 5 to 500 pixels, usually about 7 to 100 pixels, where each pixel ranges in size from about 2 to 15 microns, usually from about 4 to 12 microns and usually from about 5 to 10 microns. As such, the level of fluorescence detected from a first pixel is substantially the same as that detected fluorescence from each of five to ten substantially adjacent pixels. In other words, the quantity of light emitted from between about five to ten substantially adjacent pixels will have minimal variation or nonuniformity.

The global variation or nonuniformity is similarly minimal. By global variation or nonuniformity is meant a statistically relevant value (mean, median, etc.) corresponding to all or substantially all of the individual local variations of the entire scannable region of a subject calibration device. As noted above, the exact global nonuniformity requirement may vary depending on a variety of factors. In certain embodiments, the global nonuniformity is typically less than about 10%, usually less than about 5% and more usually less than about 4%, 3%, 2%, 1% or 0.5%. In other words, the quantity of light emitted from each local area will be substantially the same as or similar to the quantity of light emitted from each other local area.

A subject uniformly fluorescent solid support has a fluorescent agent that it is distributed substantially uniformly on its surface. In other words, a fluorescent agent is homogenously dispersed on the surface of the solid support such that the concentration of the fluorescent agent(s) is substantially constant throughout the solid support surface. For example, a fluorescent agent may be distributed such that the amount of fluorescent agent in any given area is substantially the same for all areas of the polymer layer. It will be apparent that if more than one fluorescent layer is used, all fluorescent agents employed may be distributed substantially uniformly throughout the support.

The concentration of the fluorescent agent (i.e., the concentration of each fluorescent agent if there is more than one) may vary depending on the particular scanning detector to be calibrated, the type and/or number of fluorescent agents used, etc., and the threshold level of fluorescence used. In certain embodiments, the final concentration of fluorescent agent will range from about 1 to 5000 ppp (parts per pixel), usually from about 10 to 500 ppp and more usually from about 20 to 200 ppp. In certain embodiments, the dye may be present 1 ppb-200 ppm, relative to other molecules present on the surface of the support, e.g., a plastic carrier on the surface of the support.

As mentioned above, the subject calibration devices have a plurality of photobleached regions, e.g., regions corresponding to pixels. The photobleached regions typically have a level of fluorescence that is the same as or similar to (e.g., +/−3% of, +/−2% of, +/−1% of, +/−0.5% of, +/−0.1% of) the threshold level of fluorescence. Typically, over 50%, over 60%, over 70%, over 90%, or over 95% of the scannable region of a uniformly fluorescent solid support is photobleached.

A subject device may also include one or more background features. The background area is an area that is outside of the field of uniform fluorescence but within the scannable region of the solid support that is not fluorescent, e.g. contains no fluorescent agent, or contains only photobleached fluorescent agents.

Array Readers

Also provided by the subject invention is a chemical array reader, e.g. a scanner, that contains a system for performing the subject methods described above. Typically, such readers have a laser excitation system for emitting light from the surface of a chemical array array, hardware for performing the methods described above, and, usually, a storage medium for storing data produced by scanning. A subject scanner may also contain programming for executing the subject methods. In other words, using the programming set forth above, a reader may be used to automatically make a uniformly fluorescent solid support from a non-uniformly fluorescent solid support. In such embodiments, a non-uniformly fluorescent solid support is typically loaded into a reader, and the reader, without any further human input, photobleaches that support to produce a uniformly fluorescent solid support, as described above.

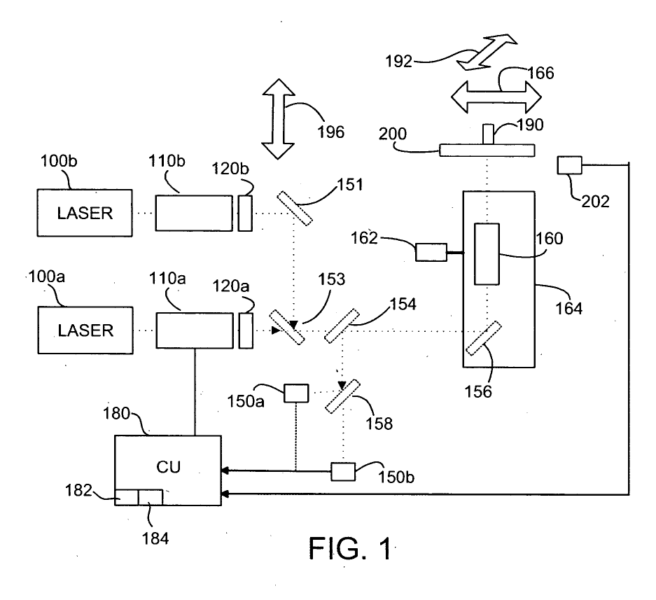

Any biopolymer array reader may be provided to include the above programming. Representative array readers of interest include those described in U.S. Pat. Nos. 5,585,639; 5,760,951; 5,763,870; 6,084,991; 6,222,664; 6,284,465; 6,329,196; 6,371,370 and 6,406,849—the disclosures of which are herein incorporated by reference. An exemplary optical scanner as may be used in the present invention is shown in FIG. 1.

Referring now to FIG. 1, an exemplary apparatus of the present invention (which may be generally referenced as an “array scanner”) is illustrated. A light system provides light from a laser 100 that passes through an electro-optic modulator (EOM) 110 with attached polarizer 120. Each laser 100a, 100b may be of different wavelength (e.g., one providing red light and the other green) and each has its own corresponding EOM 110a, 110b and polarizer 120a, 120b. The beams may be combined along a path toward a holder or caddy 200 by the use of full mirror 151 and dichroic mirror 153. A control signal in the form of a variable voltage applied to each corresponding EOM 110a, 110b by the controller (CU) 180, changes the polarization of the exiting light which is thus more or less attenuated by the corresponding polarizer 120a, 120b. Controller 180 may be or include a suitably programmed processor. Thus, each EOM 110 and corresponding polarizer 120 together act as a variable optical attenuator which can alter the power of an interrogating light spot exiting from the attenuator. The remainder of the light from both lasers 100a, 100b is transmitted through a dichroic beam splitter 154, reflected off fully reflecting mirror 156 and focused onto an array mounted on holder 200, using optical components in beam focuser 160. Light emitted (in particular, fluorescence) at two different wavelengths (e.g., green and red light) from features on the array, in response to the interrogating light, is imaged using the same optics in focuser/scanner 160, and is reflected off mirrors 156 and 154. The two different wavelengths are separated by a further dichroic mirror 158 and are passed to respective detectors 150a and 150b.

More optical components (not shown) may be used between the dichroic and each detector 150a, 150b (such as lenses, pinholes, filters, fibers, etc.) and each detector 150a, 150b may be of various different types (e.g., a photo-multiplier tube (PMT), CCD or an avalanche photodiode (APD)). All of the optical components through which light emitted from an array 12 or calibration member 230 in response to the illuminating laser light, passes to detectors 150a, 150b, together with those detectors, form a detection system. This detection system has a fixed focal plane. A scan system causes the illuminating region in the form of a light spot from each laser 100a, 100b, and a detecting region of each detector 150a, 150b (which detecting region will form a pixel in the detected image), to be scanned across multiple regions of an array or array package mounted on holder 200. The scanned regions for an array will include at least the multiple features of the array. In particular the scanning system is typically a line by line scanner, scanning the interrogating light in a line across an array when at the reading position, in a direction of arrow 166, then moving (“transitioning”) the interrogating light in a direction into/out of the paper as viewed in FIG. 1 to a position at an end of a next line, and repeating the line scanning and transitioning until the entire array has been scanned.

This scanning feature is accomplished by providing a housing 164 containing mirror 158 and focuser 160, which housing 164 can be moved along a line of pixels (i.e., from left to right or the reverse as viewed in FIG. 1) by a transporter 162. The second direction 192 of scanning (line transitioning) can be provided by second transporter which may include a motor and belt (not shown) to move caddy 200 along one or more tracks. The second transporter may use a same or different actuator components to accomplish coarse (a larger number of lines) movement and finer movement (a smaller number of lines). Generally, directly adjacent rows are scanned. However, “adjacent” rows may include alternating rows or rows where more than one intervening row is skipped.

The scanner of FIG. 1 may further include a reader (not shown) which reads an identifier from an array package. When identifier 40 is in the form of a bar code, that reader may be a suitable bar code reader.

Of course, the movements 166 and 192 may be accomplished by actuating holder 200 or housing 164 alone. Still further, the movement roles described for each element above may be swapped.

The system may also include detector 202, processor 180, and a motorized or servo-controlled adjuster 190 to move holder 200 in the direction of arrow 196 to establish correct focus for the system. The detector may directly detect a partial reflection from another beamsplitter (not shown) between splitters 153 and 154. In addition, autofocus system 202 may contain a position detector e.g. a quadrature position encoder, also feeding back to the CU measures the absolute position (i.e., relative to the apparatus) of the servo-controlled adjuster 190. As above with respect to movements 166 and 192, it should be observed that focus servo control movement 196 may occur in connection with housing 164 instead of the holder, or, if the detection system is not a fixed focal plane system, by an adjustment of laser focuser 160. Further details regarding suitable chemical array autofocus hardware is described in pending U.S. patent application Ser. No. 09/415,184 for “Apparatus And Method For Autofocus” by Dorsel, et al., filed Oct. 7, 1999, as well as European publication EP 1091229 published Apr. 11, 2001 to the same title and inventors.

Controller 180 of the apparatus is connected to receive signals from detectors 150a, 150b (these different signals being different “channels”), namely a signal which results at each of the multiple detected wavelengths from emitted light for each scanned region of array 12 when at the reading position mounted in holder 200. Controller 180 also receives the signal from autofocus detector 202, and provides the control signal to EOM 110, and controls the scan system. Controller 180 contains all the necessary software to detect signals from detector 202, and regulate a motorized or servo-controlled adjuster 190 through a control loop. Controller 180 may also analyze, store, and/or output data relating to emitted signals received from detectors 150a, 150b in a known manner.

Controller 180 also includes a programmable digital signal processor for performing the methods described above. In certain embodiments, controller 180 includes plurality of analog-to-digital converters, and other components of a multi-gain photodetection system, e.g., a current-to-voltage converter, voltage amplifier, etc., as desired, a media reader 182 which can read a portable removable media (such as a magnetic or optical disk), and a communication module 184 which can communicate over a communication channel (such as a network, for example the internet or a telephone network) with a remote site (such as a database at which information relating to array package 30 may be stored in association with the identification 40).

In one mode of operation, an array in a package is typically first exposed to a liquid sample. This liquid sample may be placed directly on the array or introduced into a chamber through a septa in the housing of the array. After a time to allow, for example, hybridization, the array may then be washed and scanned with a liquid (such as a buffer solution) present in the chamber and in contact with the array, or it may be dried following washing. After mounting a given array in cradle 200 (either with the array features on the glass surface nearer to, or further from, the lens—depending, at least, upon the lens setup) the identifier reader may automatically (or upon operator command) read an identifier from the array package, which may be used to e.g. retrieve information on the array layout from a database containing the identifier in association with such information. Such a database may be a local database accessible by controller 180 (such as may be contained in a portable storage medium in drive 182.

The saved results from a sample exposed array, read with the methods described above, may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication of data representing the results) to a remote location if desired, and received there for further use (such as further processing).

While it is noted that a scanner that reverses scanning direction at the end of each scan line (i.e. a bidirectional scanner) is disclosed, unidirectional scanners also find use with the methods of the invention.

Utility

As mentioned above, the subject uniformly fluorescent solid supports find use in calibrating optical readers, particularly chemical array scanners and more particularly biopolymeric array optical detectors, lenses, stages and mirrors. Accordingly, the invention provides solid supports used for calibrating an array rader, such as a chemical array scanner as described above. More particularly, the invention provides compositions used to calibrate the optical system's scale factor (i.e., the sensitivity of the system's optical detector), focus position (i.e., the distance between the system's stage and lens(es), dynamic focus (i.e., the rate of speed the stage travels), the scanner mirror and to verify the system's jitter.

The readers suitable for calibration generally include at least one light source for generating at least one coherent light beam at a particular wavelength, a scanning means for scanning the beam over a substrate surface such as an array surface and a light detector for detecting a light produced from the sample regions on the substrate surface, e.g., fluorescence. Such readers are well known in the art.

Also provided by the subject invention are methods for calibrating an array reader and subsequently using the calibrated reader to scan an array, more specifically a biopolymeric array, e.g., a nucleic acid array. More specifically, in the subject methods, an array reader, e.g., a scanner, is calibrated, i.e., a detector, a lens, a stage and/or a mirror of a reader is adjusted, an array is provided and a hybridization assay is performed with the array and one or more samples or agents of interest. The hybridized array is then read by the calibrated reader, where such steps may be performed serially or simultaneously.

Accordingly, an array reader, e.g., a biopolymeric array optical scanner, may be calibrated using a subject composition. More specifically, one or more of the following is confirmed and/or adjusted: (1) scale factor (i.e., the sensitivity of the optical detector is adjusted), (2) the focus position (i.e., the distance between the stage and one or more lenses are adjusted), (3) the dynamic focus (i.e., the rate of speed the stage travels is adjusted), (4) the scanner mirror (i.e., the synchronicity of the light beams is adjusted), and (5) the jitter, as described above. In other words, generally, a subject calibration device may be read using a reader, fluorescent data from the calibration device is obtained, and any necessary adjustments made to the reader.

Accordingly, a biopolymeric array may be exposed to a sample (for example, a fluorescently labeled polynucleotide or protein-containing sample) and the array is then read using an apparatus calibrated according to the subject invention. Reading of the array may be accomplished by illuminating the array and reading the location and intensity of resulting fluorescence at each feature of the array. For example, a scanner, and more particularly a scanner calibrated according to the subject invention, may be used for this purpose which is similar to the GENEARRAY scanner available from Agilent Technologies, Palo Alto, Calif. Other suitable apparatus and methods are described in U.S. patent applications: Ser. No. 09/846,125 “Reading Multi-Featured Arrays” by Dorsel et al.; and Serial No. 6,406,849 “Interrogating Multi-Featured Arrays” by Dorsel et al. These references are incorporated herein by reference.

More specifically, the hybridization array is placed in a calibrated optical scanner, i.e., is positioned in operative association with the calibrated optical means described above. In certain embodiments, a plurality of such hybridized arrays may be positioned in operative association with the calibrated optical means, for example a plurality may be indexed in an indexing means such as a carousel or the like, whereby each array is moved into a scanning position or is scanned by the optical means, followed by the scanning or reading of another array, i.e., an array positioned in an adjacent position in the indexing means to the previous scanned array. Regardless of the number of scanned arrays, an array is illuminated with at least one light source and the light emitted by each of the fluorescent labels thereon is detected by the calibrated detector. Specifically, a signal or voltage related to the presence and/or quantity of light emitted by the fluorescent labels is detected. Patents describing methods of optically detecting fluorescently labeled arrays include, but are not limited to: U.S. Pat. Nos. 5,631,734 and 5,981,956, the disclosures of which are herein incorporated by reference. Thus, it will be apparent that using the calibrated optical system to scan an array will result in more accurate and precise array scans.

Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

In certain embodiments, as mentioned above, the subject methods include a step of transmitting data from at least one of the detecting and deriving steps, as described above, to a remote location. By “remote location” is meant a location other than the location at which the array is present and hybridization occur. For example, a remote location could be another location (e.g. office, lab, etc.) in the same city, another location in a different city, another location in a different state, another location in a different country, etc. The data may be transmitted to the remote location for further evaluation and/or use. Any convenient telecommunications means may be employed for transmitting the data, e.g., facsimile, modem, Internet, etc.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

Kits

Kits for use in connection with the subject invention may also be provided. Such kits preferably include at least a) a uniformly fluorescent solid support, as described above, and/or b) computer readable medium including programming as discussed above, and, in most embodiments, instructions for using the components of the kit in the subject methods. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading feature extraction software. Alternately, the combination may be provided in connection with new software. In many embodiments, the instructions will serve as a reference manual (or a part thereof) and the computer readable medium as a backup copy to the preloaded utility.

The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or world wide web. Some form of access security or identification protocol may be used to limit access to those entitled to use the subject invention. As with the instructions, the means for obtaining the instructions and/or programming is generally recorded on a suitable recording medium.

In addition to the subject feature extraction software and instructions, the kits may also include one or more reference scans, e.g., two or more reference array scans for use in testing a scanner after calibration.

### EXAMPLES

The following example is put forth so as to provide those of ordinary skill in the art with a complete disclosure and description of how to make and use the present invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

The following method describes an exemplary method of manufacturing the subject calibration devices.

### Example 1

### Method Using Dye Mask

A non-uniformly fluorescent 1 inch by 3 inch glass substrate with a coating of Cy5 dye dissolved in a polymeric organic molecule (PMMA) was prepared by spinning the solution on a larger substrate and dicing it to size. Scanning it gave a global uniformity of 3.4%. The data from this scan was in a format that an image-processing program interpreted as an image (Irfanview, described at the world wide website of irfanview.com). The roughly 65,000-count data range was converted to a 256-level gray scale by the image processing program. The contrast/brightness was adjusted to give an optical density of about 1 in areas that were intended to give minimum bleaching, and about 0 in areas intended for maximum bleaching. This image was exported into a computer-aided design program (Intellicad, San Diego, Calif.) and merged with a template showing the outline of the 1″×3″ slide, and an outline of the sub-area into which the image was to be placed. The combined template and mask image was then printed on a sheet of transparency film using a Hewlett Packard Color Laserjet 4500DN. The image was cut to 1″ by 3″ and placed on the back side of the substrate, so that the exposure was through the substrate. The article was placed in a fixture to assure sufficient alignment. The fixture was placed into the beam of a scanning Argon laser with a nominal 3 W output. The beam was decollimated with a simple 300 mm focal length lens placed about 500 mm from the substrate. The substrate was exposed to the scanned laser beam for one hour. An improved uniformity fluorescent substrate was made using this process. This substrate had a global uniformity of 2.67%. Further exposure to the laser decreases non-uniformity.

### EXAMPLE 2

### Method Using Scan Bleaching

A non-uniformly fluorescent substrate is scanned to obtain a data set that describes the fluorescence intensity of every pixel or region of interest. The analyzing computer calculates the minimum intensity averaged over areas of sufficient size to remove individual pixel noise. The minimum is used to establish the no-bleach areas. Pixels with fluorescence above a threshold fluorescence are determined by the calculated minimum plus or minus an acceptable margin would be bleached.

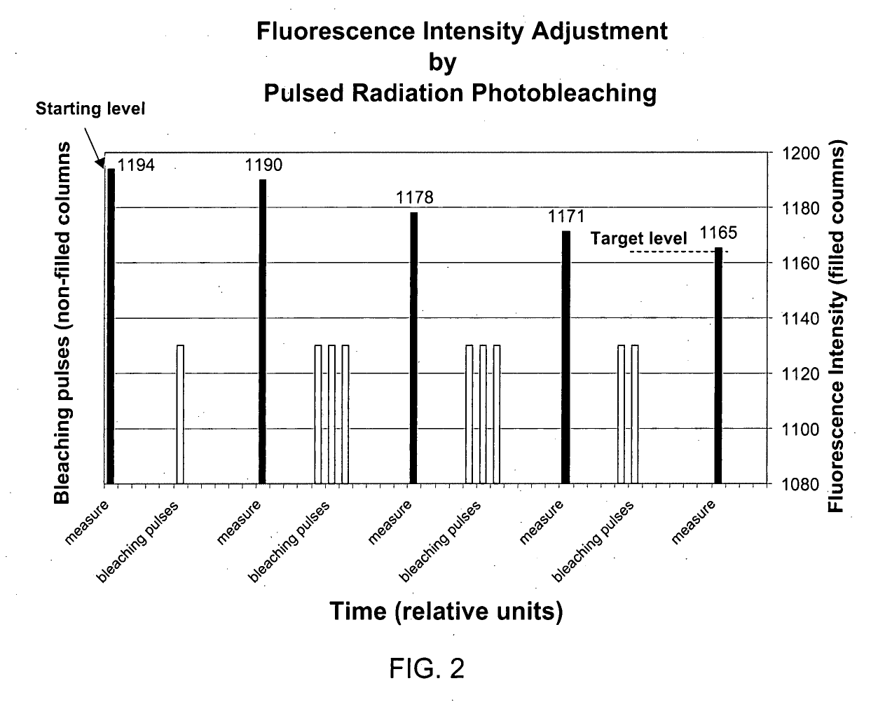

The scan starts at the first row and column element and performs a fluorescence measurement. This is shown as the first bar on the left of FIG. 2. Since the fluorescence is greater than the threshold, the pixel is given a pulse of bleaching light, shown by the second bar on the figure. The analysis computer determines that this is not a piece of non-bleachable contamination (that is, it bleached with the light pulse), and calculates that a higher amount of pulsing can be used to bleach the fluorescence faster. The next three columns represent three more pulses from the bleach light, after which another measurement is made. This pattern of test-bleach goes on until the fluorescence is at the threshold, within the allowable tolerances of the measurement. Then, the substrate or laser beam is moved to the next pixel and the steps repeated.

It is evident from the above results and discussions that the above described invention provides a simple and efficient way of calibrating an array reader, particularly a biopolymeric array optical scanner. The above described invention provides for a number of advantages, including producing a stable output at the frequency or wavelength of interest, minimal local and global nonuniformities, ease of manufacture and ease of use. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

1. A method for making a uniformly fluorescent solid support, comprising:
photobleaching regions of a non-uniformly fluorescent solid support that fluoresce at an intensity above a pre-determined threshold level to produce a uniformly fluorescent solid support.

2. The method of claim 1, wherein said regions of said non-uniformly fluorescent solid support are photobleached by:
a) assessing fluorescence in said regions using a fluorescence reader; and,
b) photobleaching said regions until they do not exceed said pre-determined threshold.

3. The method of claim 2, wherein said reader is a scanner.

4. The method of claim 1, wherein said region are photobleached using a laser and a light mask.

5. The method of claim 4, wherein said fluorescent solid support is read to provide a data file for said non-uniformly fluorescent solid support, and said light mask is designed using said data file.

6. The method of claim 1, wherein said method comprises:
placing said non-uniformly fluorescent solid support in a reader;
assessing fluorescence of a first region of said non-uniformly fluorescent solid support using said reader;
photobleaching said first region using a laser of said reader until said region has a pre-determined level of fluorescence;
assessing fluorescence of a second region of said non-uniformly fluorescent solid support using said reader; and,
photobleaching said second region using a laser of said reader until said second region also has said pre-determined level of fluorescence.

7. The method of claim 6, wherein said region is a pixel.

8. The method of claim 6, wherein said assessing and photobleaching steps are repeated until said solid support has a uniform fluorescence.

9. The method of claim 1, wherein said uniformly fluorescent solid support has less than less than about 3% local and global nonuniformity in fluorescence.

10. A composition, comprising:
a solid support coated in a fluorescent agent,
wherein said solid support has minimal local and global nonuniformities of fluorescence and contains a plurality of photobleached regions.

11. The composition of claim 10, wherein said solid support comprises a polymer layer comprising said fluorescent agent.

12. The composition of claim 10, wherein said solid support is a planar solid support.

13. The method of claim 10, wherein said solid support has less than less than about 3% local and global nonuniformity.

14. A chemical array reader comprising a composition of claim 10.

15. A method for calibrating a chemical array reader, comprising:
a) reading a composition of claim 9 with said reader to obtain a data file; and
b) calibrating said chemical array reader using said data file.

16. The method of claim 14, wherein said calibrating comprises:
assessing focus position of said chemical array reader;
assessing dynamic focus of said chemical array reader;
assessing a scanner mirror of said chemical array reader; or
assessing jitter of said array reader.

17. The method of claim 16, further comprising adjusting said reader.

18. A method for performing a hybridization assay, said method comprising:
(a) calibrating an array reader with a composition of claim 10 to provide a calibrated array reader,
(b) performing a hybridization assay with a chemical array, and
(c) reading said chemical array with said calibrated array reader to provide data.

19. The method of claim 18, wherein said array reader is an array scanner.

20. A method comprising transmitting to a remote location data obtained by a method of claim 18.

21. A method comprising receiving from a remote location data obtained by a method of claim 18.

22. A kit for calibrating a chemical array reader, said kit comprising:
a composition of claim 10.
